(19) United States
(12) Patent Application Publication
(10) Pub. No.: US 2026/0338474 A1
(43) Pub. Date: Oct. 29, 2026

(54) DEVICE FOR INDUCTIVELY HEATING METAL

(71) Applicant: ABP INDUCTION SYSTEMS GMBH, Dortmund (DE)

(72) Inventors: Alexander Keller, Dortmund (DE); Benjamin Kramm, Dortmund (DE); Stefan Landtreter, Bochum (DE); Christian Lindecke, Dortmund (DE); Patrick Lueck, Herne (DE)

(21) Appl. No.: 19/490,343

(22) PCT Filed: Jun. 6, 2024
(86) PCT No.: PCT/EP2024/065677

§ 371 Date: Dec. 4, 2025

(30) Foreign Application Priority Data
Jun. 8, 2023 (DE) 10 2023 115 104.5

(51) Int. Cl. F27B 14/06; F27D 21/00; F27D 27/00; F27D 99/00

(52) U.S. Cl. CPC F27B 14/065; F27D 21/0014; F27D 21/0028; F27D 27/00; F27D 99/0006; F27D 2099/0015

(57) ABSTRACT

A device for inductively heating molten metal, which has at least one melting chamber with an inductor, a material supply system, and a discharge chamber for the molten metal, wherein the discharge chamber has a transfer portion which is designed to discharge molten metal to a downstream unit, and the material supply system supplies material to the melting chamber in response to a fill level signal, wherein a fill level measuring apparatus is provided which detects a fill level of the molten metal and actuates the material supply system using the fill level signal when the fill level falls below a predetermined minimum fill level.

The present invention relates to a device for inductively heating metal, in particular for inductively heating molten metal, wherein the device has at least one melting chamber with at least one inductor, a material supply system, and a chamber for the molten metal. Such a device is also referred to as a multi-chamber melting furnace.

DE 10 2021 121 030 A1 discloses a multi-chamber melting furnace for melting scrap metal, in particular aluminum scrap, said melting furnace having a melting chamber for charge material in which contaminants in the charge material can be removed. The multi-chamber melting furnace also has a heating chamber, which is connected to the at least one melting chamber and has an apparatus for supplying heat. To charge the multi-chamber melting furnace with scrap, a charging furnace, via which the scrap metal is supplied, is known.

DE 15 83 460 A1 discloses a channel-type inductor which is arranged on the underside of a furnace and heats melt located in the furnace. The channel-type inductor comprises a channel which is formed from a fireproof material and runs in a semicircle and which has an inlet and an outlet portion and is filled with liquid metal during operation. Alternating current flows through an induction coil of the inductor, and the induction coil initiates eddy currents in the molten metal which lead to heating of the molten metal. In addition to channel-type inductors, crucible inductors are also known, such as those in DE 10 2017 102 924 A1 .

The object of the present invention is to provide a device for inductively heating molten metal, which device can supply a downstream production line with molten metal continuously and without interruption.

According to the invention, the object is achieved by a device having the features of claim 1. Advantageous embodiments are the subject matter of the dependent claims.

The device according to the invention is provided and designed to inductively heat molten metal. The device has at least one melting chamber with at least one inductor, a material supply system, and a discharge chamber for the molten metal. According to the invention, it is provided that the discharge chamber has a transfer portion which is designed to discharge liquid molten metal to a downstream unit. It is also provided that the material supply system supplies material to the melting chamber in response to a fill level signal, wherein a fill level measuring apparatus is provided, which detects a fill level of the molten metal and actuates the material supply system using the fill level signal when the fill level falls below a predetermined minimum fill level. The invention's achievement of the object is based on the knowledge that it is not possible to provide a continuous, uninterrupted material flow of molten metal for a downstream unit by automatically and uniformly charging the system with material, but rather that it is only achievable when the fill level in the melting furnace is monitored and the material supply system is controlled accordingly using a fill level signal. By checking the minimum fill level, it can be ensured that melting and heating processes of different lengths do not lead to a non-uniform flow of material, but rather that the flow of material stays reliably constant.

In a preferred development, the fill level measuring apparatus actuates the material supply system such that, at the transfer portion, the fill level of the molten metal is nearly constant. In particular when the transfer portion is designed as an overflow for the molten metal, a nearly constant fill level is important for a uniform flow of material.

In a preferred development, the furnace is a multi-chamber melting furnace, in which the individual chambers are separated from each other by partition walls. In order to avoid oxidation on the surface of the molten metal, the partition wall extends into the molten metal such that the molten metal enters the adjacent chamber by passing under the partition wall at the bottom of the chamber instead of over it at the surface. The discharge chamber is partitioned off by a first partition wall extending into the molten metal, such that the molten metal passes under the partition wall at the bottom of the discharge chamber instead of over it at the surface. Preferably, a second partition wall that extends into the molten metal and partitions off the melting chamber is also provided.

In a preferred embodiment, a mixing chamber is provided between the discharge chamber and the melting chamber. The first partition wall thus separates the mixing chamber from the discharge chamber, while the second partition wall separates the melting chamber from the mixing chamber. One or more of the following elements can be present in the mixing chamber: a stirring unit for the molten metal, a temperature measuring apparatus, and a closable lid. A predetermined atmosphere can be generated in the mixing chamber using the closable lid. In order to have a targeted effect on the molten metal, a feed for flushing gas can additionally be provided at the bottom of the mixing chamber and/or discharge chamber. The temperature measuring apparatus can be provided, for example, in order to control the inductor, which is controlled according to the measured temperature value in order to keep the molten metal within a predetermined temperature range. In a preferred embodiment, the melting chamber is designed with at least one channel-type inductor, which is designed to heat the melting chamber. Preferably, three or more channel-type inductors are used. All of the channel-type inductors can be operated uniformly. It is also possible to increase the power of the inductor when new material is supplied via the material supply system in order to aid the melting process. Preferably, multiple inductors are provided on the melting chamber in order to provide the necessary power and maintain a uniform flow of heat.

In a more preferred embodiment, one or more of the chambers can be provided with a suction apparatus in order to remove an atmosphere that forms above the molten metal.

Furthermore, it is provided to equip the device with one or more emergency drains which allow the molten metal to be removed quickly. The emergency drain or emergency drains are closed, for example, by means of a plug or a slider.

In a more preferred embodiment, the device with its chambers is mounted so as to be tiltable, such that the chambers and in particular the inductor can be emptied by tilting the device.

Two preferred embodiments of the invention will be described in more detail below. In the figures:

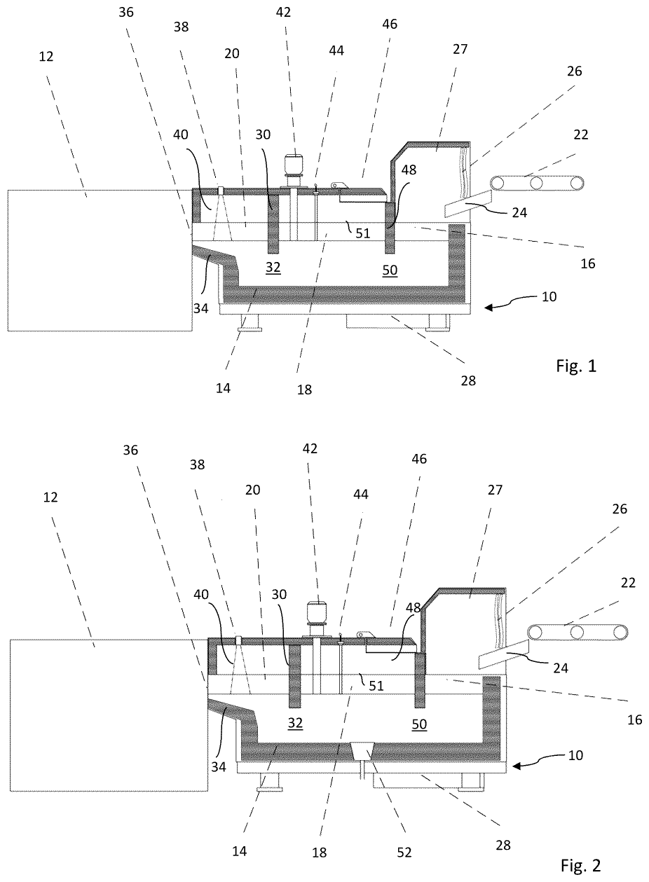

FIG. 1 shows a multi-chamber melting furnace with a conveying apparatus for supplying the melt material, and

FIG. 2 shows the multi-chamber melting furnace from FIG. 1 with an additional feed for flushing gas.

FIG. 1 shows a multi-chamber melting furnace 10 which is connected to a downstream unit 12. The multi-chamber melting furnace 10 has a fireproof lining 14. The multi-chamber melting furnace 10 is divided into a melting chamber 16, a mixing chamber 18, and a discharge chamber 20. Material is supplied by means of a conveying apparatus 22, a ramp 24, and a guard for the filling opening 26. The input material, for example aluminum scrap, is supplied to the melting chamber 16 by means of the conveying apparatus. The melt and the newly supplied scrap metal are heated in the melting chamber 16 by a channel-type inductor 28. The guard on the filling opening 26 closes the space above the melting chamber 16 and allows the scrap metal from the conveying apparatus to pass. Above the melting chamber 16, a cover 30, which can also be equipped, for example, with a suction apparatus, is provided.

The discharge to the chamber 20 is separated from the mixing chamber 18 by a first partition wall 30. The molten metal can pass from the mixing chamber 18 into the discharge chamber 20 in the region 32 below the partition wall 30. The discharge chamber 20 has a transition portion 34, via which the molten metal passes to the downstream unit 12. The amount of molten metal that passes into the downstream unit 12 is regulated by the multi-chamber melting furnace such that a continuous flow is made available and is accepted by the downstream unit 12.

To monitor the fill level, a fill level measuring apparatus 38 is provided in the discharge chamber 20. The fill level measuring apparatus performs measurements in a non-contact manner, for example optically via light beams 40, in particular laser beams. An acoustic measurement, for example by means of ultrasound, can also be provided as the non-contact measuring method of the fill level measuring apparatus. The light beam 40 detects the fill level height of the molten metal at the transfer point 36. The transfer point 36 forms a termination point of the transition portion 34. The measured fill level signal actuates, for example, the conveying apparatus 22 so that it runs for a predetermined time and introduces the input material into the melting chamber.

The mixing chamber 18 is equipped with a stirrer 42. The stirrer 42 mixes the molten metal, for example, near the first partition wall 30. The temperature measuring apparatus 44 measures the temperature in the molten metal, wherein the measured temperature value can be reported back, for example, to the channel-type inductor 28 in order to control the inductor accordingly. In addition, the mixing chamber 18 is closed using a lid 46 such that a defined gas atmosphere can form above the molten metal in the mixing chamber 18.

The mixing chamber 18 is separated from the melting chamber 16 by a second partition wall 48 such that the molten metal can pass from the melting chamber 16 into the mixing chamber 18 in the region 50 below the second partition wall 48.

FIG. 2 additionally shows a feed for flushing gas 52, which can be added accordingly to the molten metal in the mixing chamber.

The overall process in the multi-chamber melting furnace for continuously supplying material to the downstream unit 12 without interruption takes place such that input material in the form of ingots and recycled material is transported into the melting chamber 16 by means of the conveying apparatus 22 or a robot (not shown). In the process, the material is scattered into the melt bath as uniformly as possible. The submerged material is liquefied by the heat that is transferred to it from the melt. Due to the introduction of new solid input material and discharge of molten metal at the transfer point 36, the level of the melt bath fluctuates within a working range, between a maximum fill level and a minimum fill level. In addition to the height of the fill level in the working range, the temperature of the molten metal can also be regulated by the temperature measuring apparatus 44, and the inductor 28 can be controlled accordingly taking into account the fill level. The energy necessary to melt the metal and keep it warm is supplied to the bath in the form of heat by the inductor 28.

After passing through the melting chamber 16, the material passes through the mixing chamber 18 of the melting furnace. Here, when the lid 46 is open, samples can also be taken or additives can be added to the molten metal, for example. The movement of the bath and a homogeneous temperature distribution can also be aided by the stirrer 22.

The molten metal is transferred at the transfer point 36 to a downstream unit 12, for example a downstream furnace.

1. A device for inductively heating molten metal, which has at least one melting chamber (16) with an inductor (28), a material supply system (22, 24), and a discharge chamber (20) for the molten metal, characterized in that the discharge chamber (20) has a transfer portion (34) which is designed to discharge molten metal to a downstream unit (12), and the material supply system supplies material to the melting chamber in response to a fill level signal, wherein a fill level measuring apparatus (38) is provided which detects a fill level of the molten metal and actuates the material supply system using the fill level signal when the fill level falls below a predetermined minimum fill level.

2. The device according to claim 1, characterized in that the fill level measuring apparatus (38) actuates the material supply system (22) such that the fill level at the transfer portion is nearly constant.

3. The device according to claim 1 or 2, characterized in that the transfer portion (34) is designed as an overflow for the molten metal.

4. The device according to one of claims 1 to 3, characterized in that the discharge chamber (20) is partitioned off by a first partition wall (30) extending into the molten metal, such that the molten metal passes under the first partition wall (30) at the bottom of the discharge chamber (20) instead of over it at the surface.

5. The device according to one of claims 1 to 4, characterized in that the melting chamber (16) is partitioned off by a second partition wall (48) extending into the molten metal, such that the molten metal passes under the second partition wall (48) at the bottom of the melting chamber (16) instead of over it at the surface.

6. The device according to one of claims 1 to 5, characterized in that a mixing chamber (18) is provided between the discharge chamber (20) and the melting chamber (16).

7. The device according to one of claims 1 to 6, characterized in that the mixing chamber (18) has at least one of the following elements: a stirring unit (42) for the molten metal, a temperature measuring apparatus (44), and a closable lid (46).

8. The device according to one of claims 1 to 7, characterized in that the mixing chamber (18) and/or the discharge chamber (20) have a feed (52) for flushing gas.

9. The device according to one of claims 1 to 8, characterized in that the melting chamber has at least one channel-type inductor (28) for heating the molten metal.

10. The device according to one of claims 1 to 9, characterized in that a suction apparatus for one or more chambers is provided.

11. The device according to one of claims 1 to 10, characterized in that at least one emergency drain for emergency emptying of the chambers is provided.

12. The device according to one of claims 1 to 11, characterized in that a tilting device is provided such that the chambers and in particular the inductor can be emptied.
